(19) United States
(12) Patent Application Publication
(10) Pub. No.: US 2005/0078705 A1
(43) Pub. Date: Apr. 14, 2005

(54) Service providing system cooperative with SIP and web systems and a method therefor

(75) Inventor: Shinya Ito, Tokyo (JP)

Correspondence Address: VENABLE, BAETJER, HOWARD AND CIVILETTI, LLP, P.O. BOX 34385, WASHINGTON, DC, 20043-9998, US

(73) Assignee: Oki Electric Industry Co., Ltd., Tokyo (JP)

(21) Appl. No.: 10/959,580

(22) Filed: Oct. 7, 2004

(30) Foreign Application Priority Data
Oct. 9, 2003 (JP) 2003-350594

(51) Int. Cl. H04L 12/28

(52) U.S. Cl. 370/466

(57) ABSTRACT

In a service providing system is provided, applications of systems in different environments are allowed to work together for efficient operation. The system transfers information between a SIP system and a web system through respective cooperation managers according to a selected communication protocol, SOAP or CORBA, related to both systems. The system converts information, supplied from an information source, to information processable by the communication protocol of each system and, as a result, treats the SIP system and the web system as a cooperative system. Information managers are provided not only to manage information in one of the systems but also to access the other system to start a function of the other system. Thus, information that cannot conventionally be obtained is processed and provided to a client.

### BACKGROUND OF THE INVENTION

1. Field of the Invention

The present invention relates to a service system, and more particularly to a service system causing the SIP environment, which operates based on the Session Initiation Protocol (SIP), to cooperate with the Web (World Wide Web) environment to allow applications to work together for providing a service to clients connected to the system. The present invention also relates to a method of providing a service, and more particularly to a method of allowing applications, which operate in different environments, to work together for providing a service.

2. Description of the Background Art

Applications providing a service and delivering information are generally executed based on one of two environments: Session Initiation Protocol (SIP) environment and web (World Wide Web) environment. Those applications provide services in appropriate environments. An example of the application (AP) services in the SIP environment is an IP (Internet Protocol) telephone service, and an example of AP services in the web environment is a content delivery service. Because the service providing system in the SIP environment and that in the web environment operate independently according to the protocols that are different from each other, services in those two environments are provided separately.

When services are provided in the system, one of the problems is, for example, that a user, or a client, in the SIP environment cannot enjoy in real time an information delivery service that uses the web-AP service.

To increase efficiency in business, corporations install an expensive business application integration tool, EAI (Enterprise Application Integration). An EAI tool includes the BPM (Business Process Management) function of defining a workflow. However, respective business applications built so as to work together would neither keep track of the status of the mating application thereof nor keep in touch with each other in real time via reliable communications means to efficiently establish the communications therebetween because the web and SIP environments are separated from each other as described above. For example, each time a SIP client such as an operator makes an IP telephone call based on an ordinary routine business flow, he or she searched for a called party's telephone number via the web or the telephone directory before making a call. This means that, even with an EAI tool installed in the state of art, the corporation could not make the best use of the expensive tool, because a cooperative service that makes both environments cooperative would not be implemented.

### SUMMARY OF THE INVENTION

It is an object of the present invention to provide a service system and a method of providing a service that solves the drawbacks of the prior art and allow applications in different environment systems to work together for establishing an efficient operation.

The present invention provides a service system for transferring information with clients connected to systems built in different communication protocol environments for providing the information as a service, the service system comprising a first system operating based on a first communication protocol; and a second system operating based on a second communication protocol, wherein the first system comprises a first cooperation management section for converting information to be sent out to the second system into information processable by a third communication protocol that processes the information so that the information is processable both by the first communication protocol and the second communication protocol and for converting information supplied from the second system and processed by the third communication protocol into information processable by the first communication protocol; and a first information management section that includes at least one of a management of information based on a function of an application operating in the first system and a management of accessing a corresponding application in the second system to start the application and obtaining information processed by the application, and wherein the second system comprises a second cooperation management section for converting information to be sent out to the first system into information processable by the third communication protocol and for converting information supplied from the first system and processed by the third communication protocol into information processable by the second communication protocol; and a second information management section that includes at least one of a management of information based on a function of an application operating in the second system and a management of accessing a corresponding application in the first system to start the application and obtaining information processed by the application.

The service system in accordance with the present invention transfers information between the first system and the second system through the first cooperation management section and second cooperation management section according to the third communication protocol related to both systems. The service system converts information, supplied from an information source, into information processable by the communication protocol of each system, and, as a result, treats the first system and the second system as a cooperative system. The first and second information management sections provided respectively in the first and second systems not only manage the information in one of the systems but also start a function of the other system when an access is made to the other system. Therefore, the service system can process the information that cannot conventionally be obtained and provide the obtained information to a client.

The present invention also provides a method of providing a service to transferring information with clients connected to systems built in different communication protocol environments for providing the information as a service, the method comprising a first step of converting information, which is to be sent out from a first system, into information processable by a third communication protocol that processes the information so that the information is processable both by a first communication protocol and a second communication protocol and sending out the information, the information being transferred between the first system operating based on the first communication protocol and the second system operating based on the second communication protocol; a second step of converting the information, which is to be supplied to the second system and which is converted to the information processable by the third communication protocol, into information processable by the second communication protocol and sending out the information; a third step of converting the information, which is to be sent out from the second system and which is converted to the information processable by the second communication protocol, into information processable by the third communication protocol and sending out the information; and a fourth step of converting the information, which is to be supplied to the first system and which is converted to the information processable by the third communication protocol, into information processable by the first communication protocol and sending out the information. The method further comprises a fifth step of generating an application in the second system in response to information requested by a client connected to the second system, and sending out a start signal including the request information; and a sixth step of sequentially performing the third step and the fourth step via the start signal, performing processing under a management based on the supplied request information in the first system, supplying the obtained processing result to the second system via the first and second steps, and sending out the processing result to the client connected to the second system via the application.

The method providing a service in accordance with the present invention generates an application corresponding to request information according to the information requested by a client connected to the second system, sends out a start signal including the request information from this application, supplies the signal as well as the request information to the first system with the protocol changed from the second communication protocol to the third communication protocol, changes the communication protocol from the third communication protocol to the first communication protocol in the first system, performs processing in the first system under the management based on the supplied request information, and supplies the obtained processing result to the second system via the third communication protocol. In this way, the information not obtainable in the second system can be obtained from the first system as the processing result and, via the application, supplied to the client connected to the second system.

### BRIEF DESCRIPTION OF THE DRAWINGS

The objects and features of the present invention will become more apparent from consideration of the following detailed description taken in conjunction with the accompanying drawings in which:

FIG. 1 is a schematic block diagram showing a specific embodiment of a service providing system according to the present invention;

FIG. 2 is a schematic block diagram exemplarily showing a configuration of the accessor component shown in FIG. 1;

FIG. 3 is a schematic block diagram showing the relation between the information manager and the component APIs in the web accessor component shown in FIG. 1;

FIG. 4 is a schematic block diagram showing the relation between the information manager and the component APIs in the SIP accessor component in FIG. 1;

FIG. 5 is a sequence chart useful for understanding a specific operation procedure for a service request from a web client in the service providing system shown in FIG. 1;

FIG. 6 is a sequence chart useful for understanding a specific procedure that follows the operation procedure shown in FIG. 5;

FIG. 7 is a sequence chart useful for understanding a specific procedure that follows the operation procedure shown in FIG. 6;

FIG. 8 is a flowchart useful for understanding a specific workflow of inventory management in the EAI provided in the embodiment shown in FIG. 1; and

FIG. 9 shows an example of the display of presence information displayed on the web browser in the system shown in FIG. 1.

### DESCRIPTION OF THE PREFERRED EMBODIMENT

With reference to the accompanying drawings, a preferred embodiment of a service system according to the present invention will be described. In this embodiment, the present invention is applied to a service providing system 10. The portions not directly relevant to understanding the present invention will neither described nor shown for simplicity. In the description below, a signal is represented by the reference numeral of a line through which the signal is sent.

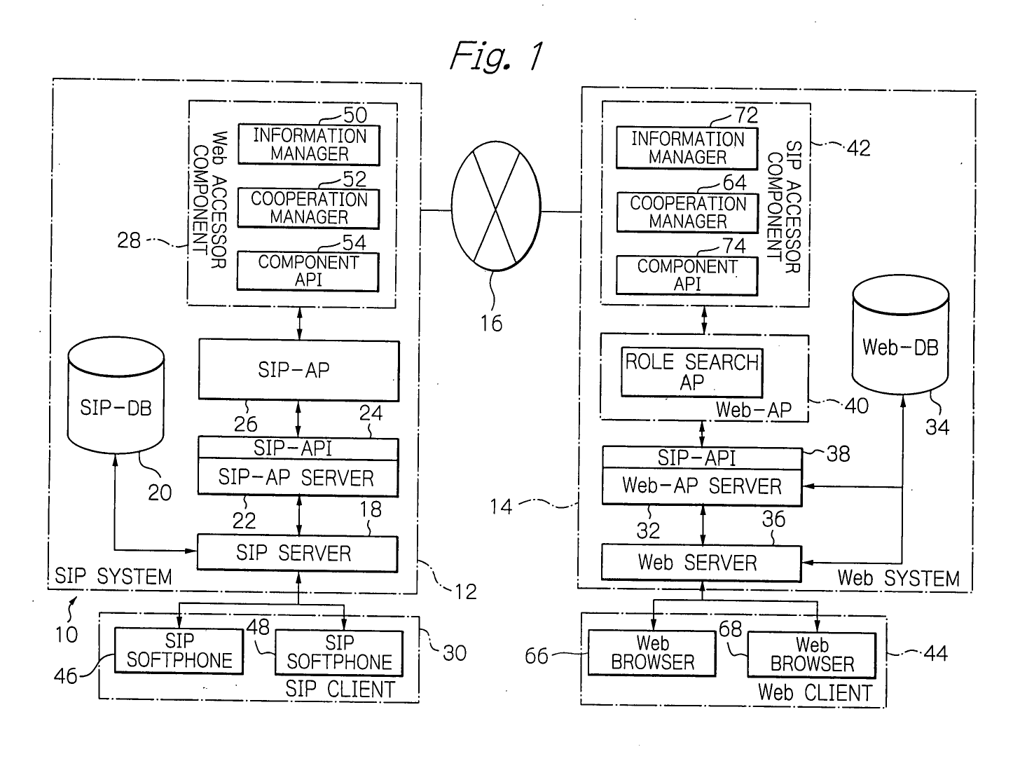

As shown in FIG. 1, the service providing system 10 in this embodiment includes a SIP system 12 and a web system 14 interconnected with each other by a network 16. The SIP system 12 and the web system 14 are in network environments belonging to different network domains. At the same time, they have functional blocks that are not usually included in the SIP system 12 and the web system 14 but that supplement the web environment and the SIP environment. This configuration allows the service providing system 10 to have one environment for each system provided in a LAN environment in one server computer or in a common domain.

The network 16, preferably a SOAP (Simple Object Access Protocol)/CORBA (Common Object Request Broker Architecture) network in the instant embodiment, is an intermediary that transfers information between the SIP system 12 and the web system 14. The SOAP is a communication protocol that defines the standard of the data format of a message exchanged between web services as well as the rule of processing a message. On the network 16, a service requester, a service provider, and a service intermediary exchange a SOAP message conforming to this standard. The CORBA is a distributed object architecture defined by OMG (Object Management Group).

The SIP system 12 comprises a SIP server 18, a SIP database (SIP-DB) 20, a SIP application server (STP-AP server) 22, a SIP application interface (SIP-API) 24, a SIP application (SIP-AP) 26, a web accessor component 28, and a SIP client 30 as illustrated. The web system 14 comprises a web server 32, a web database (web-DB) 34, a web application server (web-AP server) 36, a web application interface (web-API) 38, a web application (web-AP) 40, a SIP accessor component 42, and a web client 44 as shown. Those components will be briefly described below.

The SIP server 18 is adapted to respond to a client request based on the SIP, which is a protocol for an end-to-end based client-server model. In particular, the SIP server 18 has the function of handling and managing the SIP that conforms to RFC (Request For Comments) 3261 defined by the IETF (International Engineering Task Force). For this management function, the SIP server 18 generally includes three server functions: SIP proxy server function, SIP registrar server function, and SIP location server function. First, the SIP proxy server function acts as the proxy of a client to transfer a SIP message. Second, the SIP registrar server function manages the registration of clients. Third, the SIP location server function manages the address information on the registered clients. The SIP server 18 is connected, for example, to SIP softphones 46 and 48, which are components of the SIP client 30, for transfer of information and SIP messages provided by the SIP-AP server 22.

The SIP database 20 is a storage unit for storing user information and presence information that are associated with each other and managed by the SIP server 18. In some cases, this database is connected to the SIP server 18 for providing information in response to a search request from the SIP server 18. The user information stored in the SIP database 20 includes address information and authentication information for clients. The presence information indicates whether or not a client is connected to the SIP system 12, whether or not a client is started and used, and whether or not a client is connected with another client. As indicated by the information, the SIP database 20 stores information indicating the status of clients.

The SIP-AP server 22 is adapted to start operation as an application, managed by the SIP server 18 based on the SIP protocol, starts operation. The SIP-AP server 22 is connected to the SIP server 18 and the SIP-AP interface (SIP-API) 24, respectively. The SIP-AP interface 24 has the function of starting an application in response to a SIP request received by the SIP server 18 and the function of issuing a request to the SIP server 18. A SIP request is for session establishment, acknowledgement, communication termination, and presence change.

The SIP-AP interface 24 is provided by the SIP-AP server 22. The SIP-AP server 22 is connected to the SIP application (SIP-AP) 26 via the SIP-AP interface 24. A typical SIP-AP interface 24 is a SIP Servlet application interface currently under standardization by JCP (Java (trademark) Community Process).

The SIP application 26 is created by the connected SIP-AP interface 24 and runs on the SIP-AP server 22. The SIP application 26 is, for example, an IP telephone, an instant message, a TV (Television) telephone, and a presence communication.

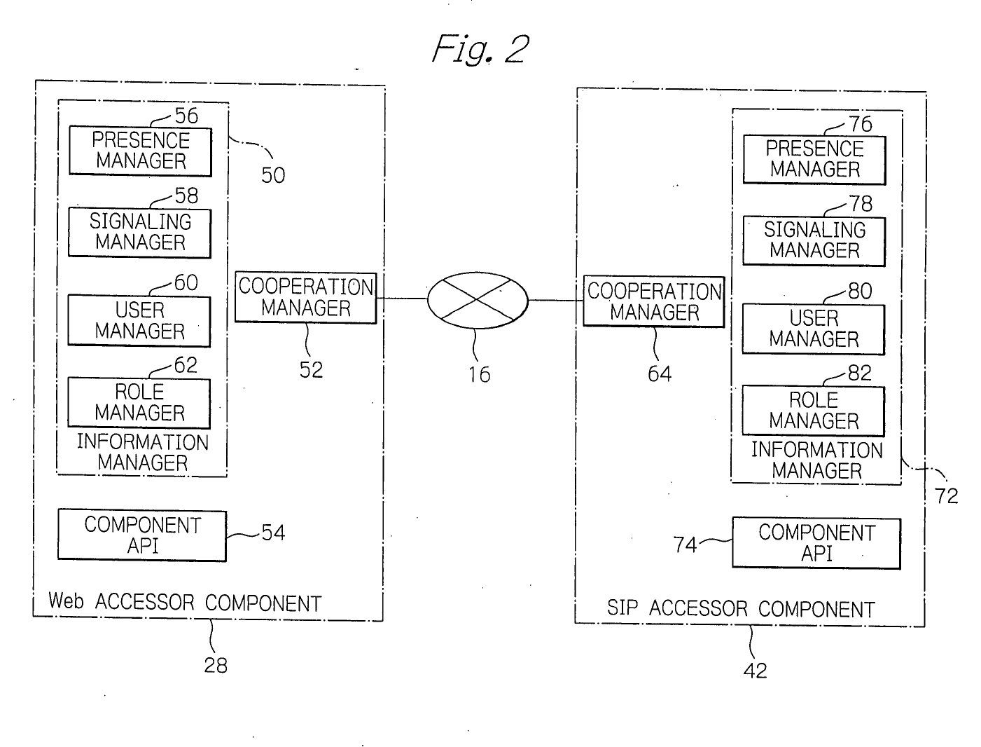

The web accessor component 28 is a generic name for the components used by the SIP application 26 to work with the web system 14 with each component representing a library software part. Therefore, the web accessor component 28 is called during the operation of the SIP application 26 for use in communication with the SIP accessor component 42 of the web system 14, which will be described later. As shown in FIG. 2, the web accessor component 28 includes an information manager 50, a cooperation manager 52, and a component application interface (component API) 54.

More specifically, the information manager 50 is a component that extends the function in the SIP system 12 for managing information. The information manager 50 includes a presence manager 56, a signaling manager 58, a user manager 60, and a role manager 62.

The presence manager 56 has the function of processing and managing presence information managed in the SIP system 12. The signaling manager 58 has the function of processing and managing SIP signaling using the SIP server 18, one of the components in the SIP system 12. The user manager 60 has the function of processing and managing user information managed in the SIP system 12. The role manager 62 has the function of processing and managing role information managed in the SIP system 12. The role information represents the division, type of job, business in charge, and job title.

The cooperation manager 52, which works with a corresponding cooperation manager 64 in the web system 14, has the function of managing the communication environment for allowing the web system 14 to access the information manager 50 and for accessing the web system 14. The cooperation management environment includes the setting of the environment corresponding to the SOAP protocol or the CORBA protocol.

The component AP interface (API) 54 functions as an interface allowing the SIP application 26 to use a component associated therewith. As will be described later, the component AP interface 54 includes the component AP interfaces associated with the constituent elements, i.e. a presence manager 56, a signaling manager 58, a user manager 60 and a role manager 62, FIG. 2, of the information manager 50.

The components included in the web accessor component 28 are not limited to those described above. The SIP application 26 can use any combination of components depending upon what function will actually be implemented as the SIP application 26. New components can be added to the components described above as necessary according to the application. Of course, as new components are added to, or the components are extended in, the information manager 50, the new types of cooperation with the web system 14 can be added or extended.

Next, returning to FIG. 1, the web system 14 will be described. The web server 32 is adapted to handle and manage information based on the HTTP. The web server 32 is connected to web browsers 66 and 68 that are components of the web client 44. The web server 32 connects to the web database (web-DB) 34 and the web-AP server 36 for managing them.

The web database 34 is a storage unit in which information managed by the web server 32 is stored. In some cases, the web database 34 provides information in response to a search request from the web server 32. The stored information is, for example, accounting information and usage log information on clients. The web database 34 is connected so that data can be provided not only to the web server 32 but also to the web-AP server 36.

The web-AP server 36, always in its activated state, starts an application managed by the web server 32 based on HTTP that is a web protocol when it is required to start the application. For example, the web-AP server 36 is TOMCAT, available as an open source program, or WebLogic (trademark) from BEA Systems, Inc. The web-AP server 36 is connected to the web application 40 via the web-AP interface 38. It is also possible for the web-AP server 36 to run an application based on the information in the web database 34.

The web-AP interface 38 is an application interface provided by the web-AP server 36. A typical AP interface used as the web-AP interface 38 is HTTP Servlet API or EJB (Enterprise Java Beans) defined for use in the J2EE (Java2 Enterprise Edition) environment. The web-AP interface 38 makes it possible to transfer information between the web-AP server 36 and the web application 40.

The web application 40 is created by the connected web-AP interface 38 and operates on the web-AP server 36. The web application 40 is connected also to the SIP accessor component 42. For example, the web application 40 may be an Internet shopping mall, an enterprise portal, content delivery as well as a role search application (AP) 70 as shown in FIG. 1. The role search application 70 extracts information from the web database 34 based on the presence information on personnel in a division such as a procurement division.

The SIP accessor component 42, a generic name for the components used by the web application 40 to work with the SIP system 12, is library software called during the operation of the web application 40. The SIP accessor component 42 is used is used when the web application 40 communicates with the web accessor component 28 in the SIP system 12. In this case, as with the web accessor component 28, the web application 40 can use any combination of components in the web application 40 side depending upon what function, which works with the SIP application 26, will actually be implemented. The SIP accessor component 42 can be extended as necessary according to the use. As new components are added or the components are extended, the new types of cooperation with the SIP system 12 can be added or extended.

As shown in FIG. 2, the SIP accessor component 42 includes such components as an information manager 72, a cooperation manager 64, and a component AP interface 74. As shown in the figure, the information manager 72 includes a presence manager 76, a signaling manager 78, a user manager 80, and a role manager 82. Each of the presence manager 76, signaling manager 78, user manager 80, and role manager 82 primarily has a module for accessing the web accessor component 28. This allows the web side to access the SIP side.

The presence manager 76 has the function of accessing the presence information, managed in the SIP system 12, to obtain the information. The signaling manager 78 has the function of using the SIP signaling via the SIP server 18 in the SIP system 12. The user manager 80 has the function of accessing user information, managed in the SIP system 12, to obtain the information. The role manager 82 has the function of accessing role information, managed in the SIP system 12, to obtain the information.

The cooperation manager 64, which works with the corresponding component in the SIP system 12, uses the presence manager 76, signaling manager 78, user manager 80 and role manager 82 of the information manager 72 to establish and manage the communication environment for accessing the SIP system 12 or for allowing the SIP system 12 to access the web system 14. The cooperation manager 64, which is responsive to the cooperation manager 52 in the SIP system 12, is adapted to perform cooperative management via the SOAP or CORBA.

The component AP interface 74 is an interface for application via which the web application 40 uses components. The respective components will be described later.

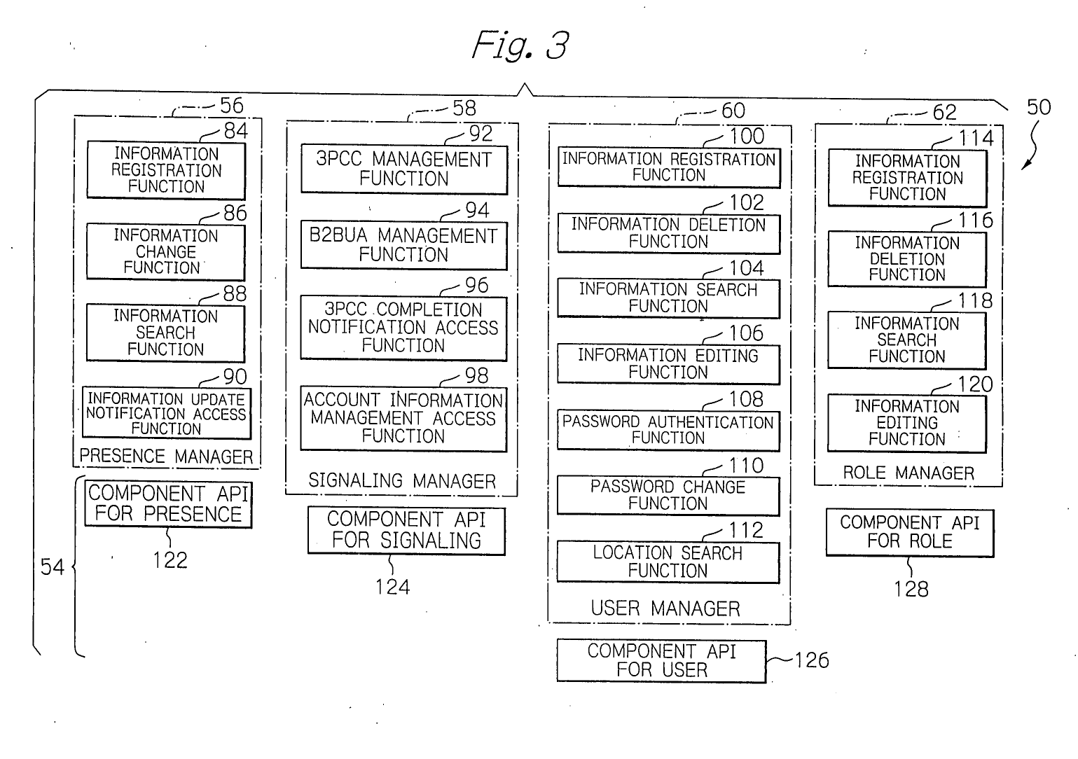

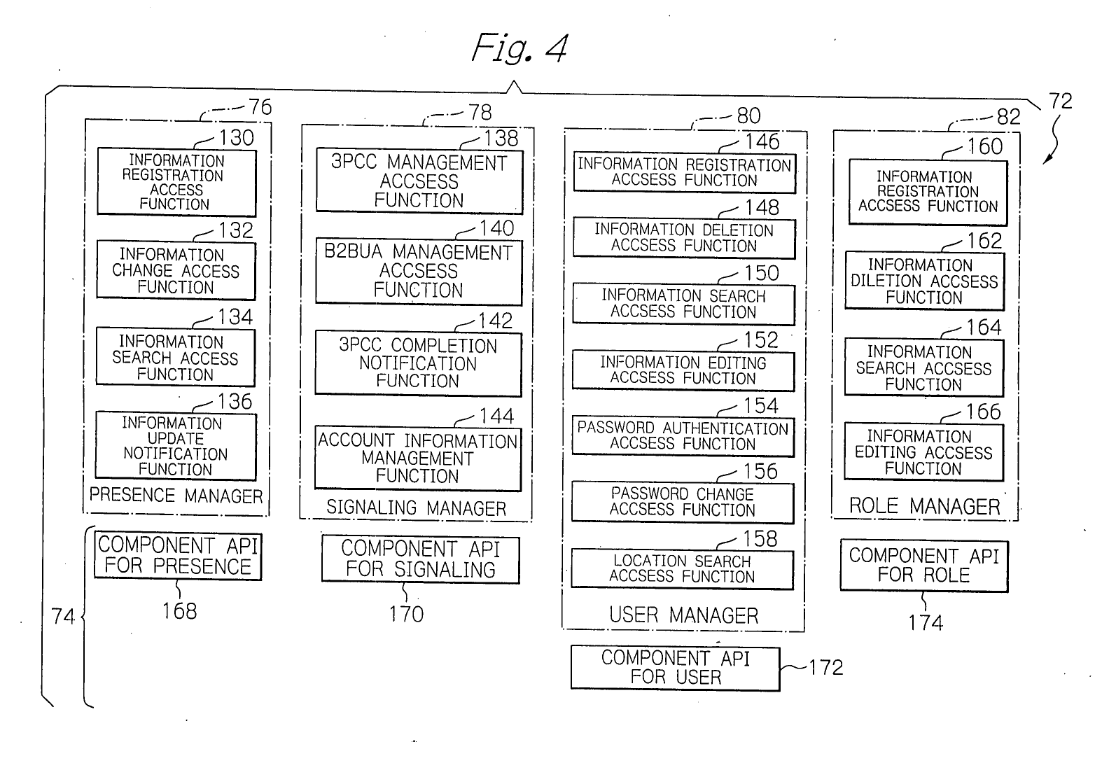

In the following, the specific constituent elements will be described of the information manager 50 in the web accessor component 28 and the information manager 72 in the SIP accessor component 42, with reference to FIG. 3 and FIG. 4.

As shown in FIG. 3, the presence manager 56 of the web accessor component 28 comprises an information registration functional section 84, an information change functional section 86, an information search functional section 88, and an information update notification access functional section 90 for processing and managing the presence information in the SIP database (SIP-DB) 20. The information registration functional section 84 is a module that registers presence information. The information change functional section 86 is a module that changes the registered presence information to the latest information. The information search functional section 88 is a module that searches for registered presence information. The information update notification access functional section 90 is a module that notifies the latest presence information updated via the SIP server 18 to the presence manager 76 of the web system 14.

The signaling manager 58 in FIG. 3 comprises a 3PCC (3rd Party Call Control) management functional section 92, a B2BUA (Back To Back User Agent) management functional section 94, a 3PCC completion notification access functional section 96, and an account information management access functional section 98 for processing and managing SIP signaling using the SIP server 18. The 3PCC management functional section 92, which performs an AP execution management function such as the Click To Dial function, is a module that provides the communication function between two parties via the SIP server 18. The B2BUA management functional section 94 is a management module that executes a communication between two communication parties as a SIP session divided into two.

The 3PCC completion notification access functional section 96 is a module that notifies the completion of 3PCC executed via the SIP server 18 to the signaling management functional section 78 of the web system 14. The account information management access functional section 98 is a module that accesses the signaling management functional section 78 in response to the completion of 3PCC executed via the SIP server 18, performs account calculation of the charge for using the service until completion in the functional section it accesses, and manages the obtained account information.

The user manager 60 comprises an information registration functional section 100, an information deletion functional section 102, an information search functional section 104, an information editing functional section 106, a password authentication functional section 108, a password change functional section 110, and a location search functional section 112 for processing and managing user information/location information that is SIP related information stored in the SIP database 20. The information registration functional section 100 is a module that registers user information. The information deletion functional section 102 is a module that deletes registered user information. The information search functional section 104 is a module that searches for registered user information. The information editing functional section 106 is a module that edits registered user information. The password authentication functional section 108 is a module that authenticates a user who accesses the system. The password change functional section 110 is a module that changes a user authentication password. The location search functional section 112 is a module that searches for the location information on a SIP client.

The role manager 62 comprises an information registration functional section 114, an information deletion functional section 116, an information search functional section 118, and an information editing functional section 120 for processing and managing the role information that is SIP related information managed in the SIP database 20. The information registration functional section 114 is a module that registers role information. The information deletion functional section 116 is a module that deletes registered role information. The information search functional section 118 is a module that searches for registered role information. The information editing functional section 120 is a module that edits registered role information.

The component AP interface 54 comprises component AP interfaces (APIs) 122, 124, 126 and 128 associated with the constituent elements of the information manager 50, that is, the presence manager 56, signaling manager 58, user manager 60, and role manager 62.

As shown in FIG. 4, the presence manager 76 of the SIP accessor component 42 comprises an information registration access functional section 130, an information change access functional section 132, an information search access functional section 134, and an information update notification functional section 136 for accessing the modules of the presence manager 56 in the SIP system 12 via the communication between the cooperation manager 52 and the cooperation manager 64 to notify the presence information to the SIP system 12. The information registration access functional section 130, information change access functional section 132, and information search access functional section 134 access the corresponding function modules in the presence manager 56 in the SIP system 12 respectively to obtain the presence information via the access function of use in the management. The information update notification functional section 136, started in response to an information notification from the information update notification access functional section 90 in the presence manager 56 in the SIP system 12 shown in FIG. 3, converts the notified presence information to a form displayable on the web browser.

The signaling manager 78 in FIG. 4 comprises a 3PCC management access functional section 138, a B2BUA management access functional section 140, a 3PCC completion notification functional section 142, and an account information management functional section 144. The signaling manager 78 is adapted to perform intercommunication with the associated components in the signaling manager 58 in the SIP system 12 via the communication between the cooperation manager 64 and the cooperation manager 52 to thereby manage the functions of those components.

The 3PCC management access functional section 138 is a module that allows the web system 14 to access the 3PCC management functional section 92 in the signaling manager 58 of the SIP system 12. The B2BUA management access functional section 140 is a module that allows the web system 14 to access the B2BUA management functional section 94 in the signaling manager 58 of the SIP system 12. The 3PCC completion notification functional section 142 is a module that receives a notification about 3PCC management execution completion in the SIP system 12 as an access and recognizes the completion of 3PCC execution requested by the web system 14. The account information management functional section 144 is a module that, in response to an access request from the account information management access functional section 98 upon completion of a service executed in the signaling manager 58 in the SIP system 12, calculates the account information on the service and manages the account information. The account information management functional section 144 in this embodiment also has the function of working with an externally installed account system not shown.

The user manager 80 in FIG. 4 comprises an information registration access functional section 146, an information deletion access functional section 148, an information search access functional section 150, an information editing access functional section 152, a password authentication access functional section 154, a password change access functional section 156, and a location search access functional section 158 for accessing the components of the user manager 60 in the SIP system 12 via the communication between the cooperation manager 64 and the cooperation manager 52. The above-described components in the user manager 80 accesses the corresponding function modules in the user manager 60 in the SIP system 12 for executing the access function set up in the web system 14.

The cooperation manager 64 and the cooperation manager 52 communicate each other as follows. For example, when the information registration access functional section 130 of the web system 14 accesses the information registration functional section 84 in the remote environment, a user information registration stub is called to work as a communication intermediary between the cooperation manager 64 and the cooperation manager 52 so that both functions work together. This stub depends on the network 16 used for remote access. Specifically, a CORBA stub is used for cooperation via CORBA while a SOAP access stub is used for cooperation via SOAP.

The role manager 82 comprises an information registration access functional section 160, an information deletion access functional section 162, an information search access functional section 164, and an information editing access functional section 166 for accessing the components of the role manager 62 in the SIP system 12 via communication between the cooperation manager 64 and the cooperation manager 52.

Each of the information registration access functional section 160, information deletion access functional section 162, information search access functional section 164, and information editing access functional section 166 accesses the role manager 62 of the SIP system 12 from the role manager 82 to obtain and manage the role information obtained by the corresponding function of the role manager 62.

The component AP interface 74 includes component AP interfaces (APIs) 168, 170, 172, and 174 associated with the components of the information manager 72, that is, the presence manager 76, signaling manager 78, user manager 80, and role manager 82.

The configuration described above allows the SIP system 12 and the web system 14 to cooperate with each other to communicate therebetween, thus achieving the unification of the SIP systems 12 and 14 for real-time communication.

Next, in the following, an example will be described in which the web client 44 performs communications using an application running on the web browser. In this example, a service is provided in which, by clicking an icon indicating the role of the “procurement personnel” in a company, a list of the presence status of the persons concerned is displayed.

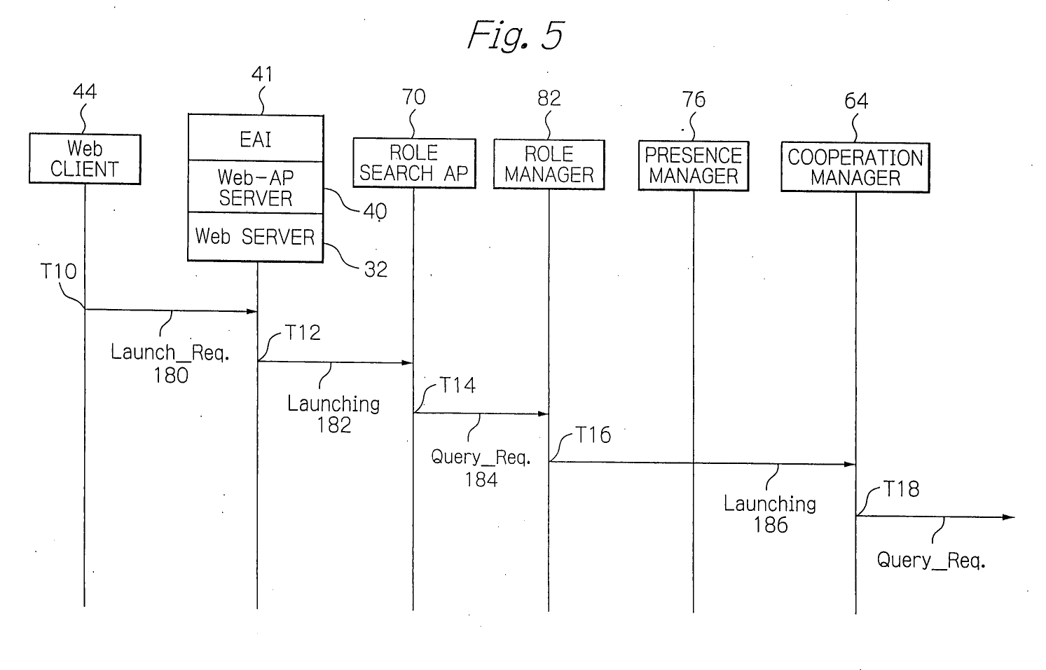

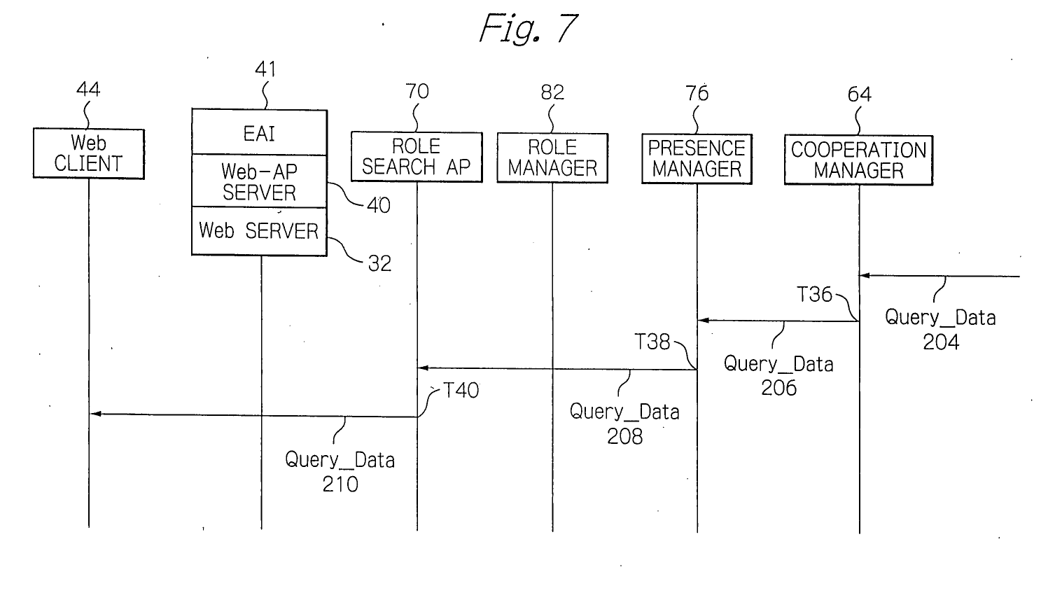

The sequence of services is executed according to the operation sequence shown in FIGS. 5, 6, and 7. In this case, the web system 14 uses the presence manager 76 and the role manager 82 of the information manager 72. Also, the SIP system 12 uses the presence manager 56 and the role manager 62 of the information manager 50.

The web client 44 issues a start request signal (Launch_Req.) 180, which starts the role search function, to the web server 32/web-AP server 36/EAI (Enterprise Application Integration) 41 of the web system 14 at time T10 so that the presence information on the roles of the procurement division is supplied to the web browser. The web server 32/web-AP server 36/EAI 41 supply a start signal (Launching) 182, generated based on the supplied start request signal 180, to the role search application 70 at time T12. In response to this signal, the role search application 70 starts the application.

The role search application 70 sends a role search request signal (Query_Req.) 184 to the role manager 82 at time T14. The role manager 82 starts the cooperation manager 64 via a start signal (Launching) 186 at time T16. Not only the start information but also the role search information is supplied to the role manager 82.

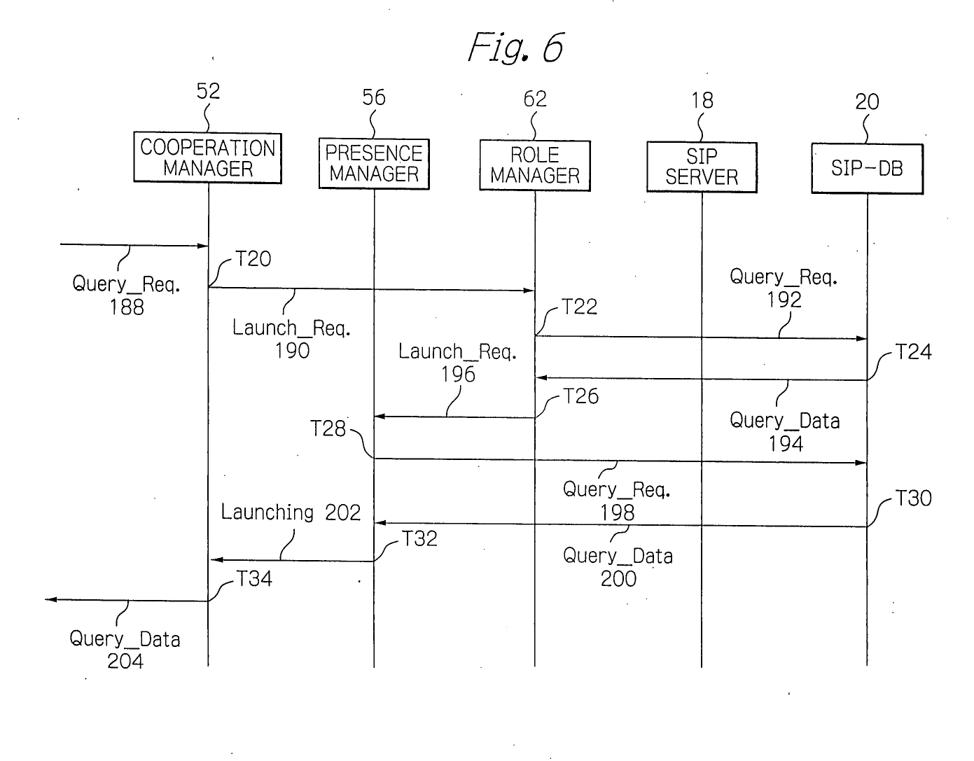

When started, the cooperation manager 64 converts a search request signal (Query_Req.) 188, which includes the supplied role search information, to a form used by the selected protocol that is one of SOAP and CORBA. At time T18, the cooperation manager 64 supplies the converted signal to the cooperation manager 52, shown in FIG. 6, that is in another domain on the SOAP/CORBA network 16. The cooperation manager 52 receives the search request signal 188 supplied from the cooperation manager 64 and indicating the information on the role. At time T20, the cooperation manager 52 supplies a start request signal (Launch_Req.) 190 to the information search functional section 118 in the role manager 62 and starts the information search functional section 118.

At time T22, the information search functional section 118 supplies the role search information, included in the search request signal (Query_Req.), to the SIP database 20 managed by the SIP-AP server 22/SIP server 18. The roll search information includes a role, pre-registered for each user, as the keyword. The SIP database 20 searches for the corresponding user names managed by role. At time T24, the SIP database 20 outputs a search result (Query_Data) 194 to the information search functional section 118 of the role manager 62.

The information search functional section 118 receives the corresponding user names as the search result. At time T26, in response to the names, the information search functional section 118 supplies a start request signal (Launch_Req.) 196 to the information search functional section 88 of the presence manager 56 and starts the information search functional section 88.

At time T28, the information search functional section 88 supplies a search request signal (Query_Req.) 198, used for searching for the presence of the received users, to the SIP database 20. The SIP database 20 searches for the presence information based on the supplied search request signal. At time T30, the SIP database 20 outputs a search result (Query_Data) 200 to the information search functional section 88 of the presence manager 56.

The information search functional section 88 receives the presence information on the users from the SIP database 20 and, at time T32, outputs a start signal (Launching) 202 to the cooperation manager 52. The cooperation manager 52, once started, performs the cooperation management processing, selects one of intermediary protocols, SOAP or CORBA and, at time T34, supplies presence information (Query_Data) 204, obtained via the search, to the cooperation manager 64 in the other domain on the SOAP/CORBA network 16, that is, the web system 14.

The cooperation manager 64 converts the presence information 204 to information (Query_Data) 206 corresponding to the web system protocol and, at time T36, outputs the converted information to the information search access functional section 134 of the presence manager 76. At time T38, the information search access functional section 134 sends information (Query_Data) 208, obtained via the search and indicating the presence information on the users, to the role search application 70.

At time T40, the role search application 70 supplies search information (Query_Data) 210 to the web browser of the web client 44 that issued the request. The web browser obtains the presence of the persons with which the browser is to communicate.

The operation described above allows applications on the SIP system 12 and the web system 14 to work together, thus making it possible to build the service providing system 10 where the web function and the VoIP function are combined together or cooperate with each other. This system 10 facilitates the creation, execution, and operation of unified or cooperative applications.

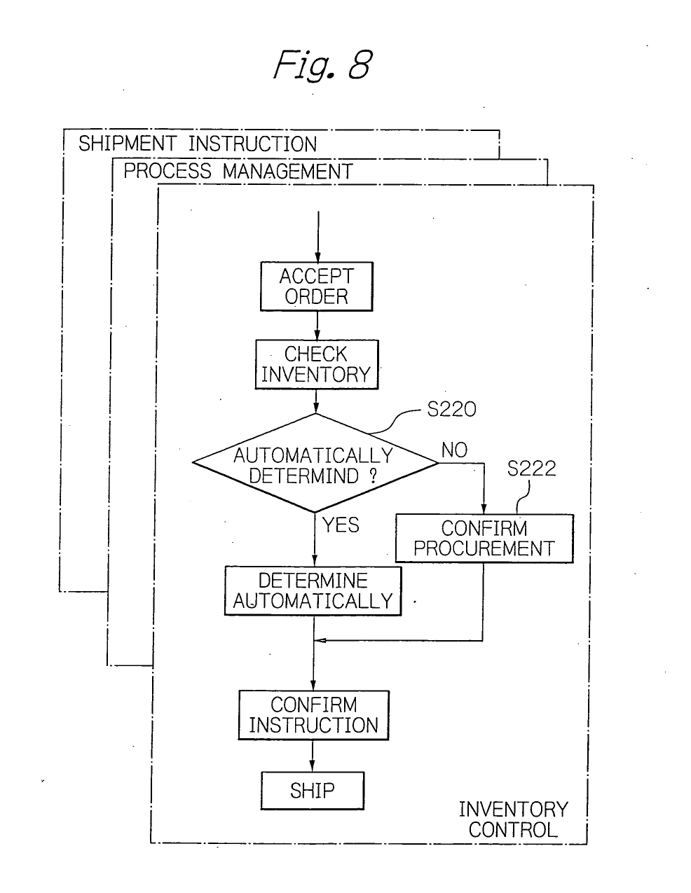

An EAI tool running on the web browser will be described below more in detail. With an EAI tool, a workflow can be defined according to a variety of business processes as shown in FIG. 8. To define a workflow, the routine processes in a day-to-day operation are grouped into blocks, the processes and work divisions or work applications are related and, at the same time, the workflow is defined.

In a process where human intervention is required, that is, communications are required, in the workflow, clicking a role-based icon sequentially starts the role search application 70 and the role manager 82, allows the web system 14 to access the SIP database 20 in the SIP system 12, and notifies the user, a web client, of the names and the presence status of the persons, assigned to the role. In this case, with persons pre-registered with the SIP database 20 by division, business in charge, and job title, a workflow can be defined simply by describing the role.

Therefore, because a BPM application can be described based on the role information, the system manager is required only to update the person-in-charge entry in the database, but is not required to change the application screen, even when the person-in-charge is replaced. Such a change, if generated, requires a change in the database but does not require the user to change the way the user uses web browser. For example, consider the inventory control process that is one of the business processes shown in FIG. 8. In this process, if human invention is required (NO) in the automatic determination process (step S220), control is passed to the procurement confirmation process (step S222). If the icon is displayed in the procurement confirmation process, the user can simply click this icon button to issue the confirmation request instruction easily to the person in change of procurement. This makes the operation simple. As is apparent from this example, a real-time communication function for use in some other BPM workflow or application can be added irrespective of the platform or the application.

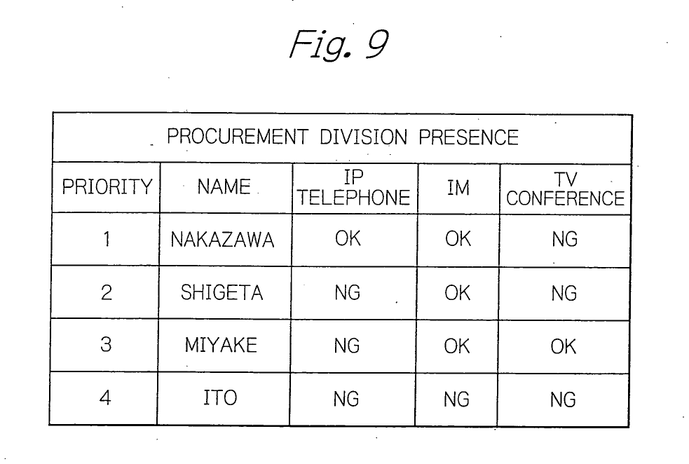

The cooperation manager, provided both in the web system 14 and the SIP system 12, allows the user in the web system 14 to confirm the presence status of a partner (member) in the SIP system 12 as shown in FIG. 9. The service providing system 10 also allows a web client to operate a SIP client in a SIP system, based on the displayed presence status, to establish a session with the SIP client for communicating audio, video, and text data. This enables a web client in the web environment to use a SIP client, where applications such as an IP telephone, a TV (Television) conference, and an IM (Instant Message) run, in response to a request from the web client.

In addition, the role management function not only displays a list of presence of the persons in charge but also assigns priority to the persons in charge as shown in FIG. 9. This function allows clients to talk directly over an IP telephone.

The above-stated configuration allows the service providing system 10 to transfer information between the SIP system 12 and the web system 14 through the cooperation manager 52 and the cooperation manager 64 according to the selected communication protocol, SOAP or CORBA, related to both systems. The service providing system 10 converts information, supplied from an information source, to a form of information processable by the communication protocol of each system and, as a result, treats the SIP system 12 and the web system 14 as a unified system. The information manager 50 and the information manager 72 provided in the service providing system 10 not only manage the information in one of the SIP system 12 and the web system 14 but also start the function of the other system when an access is made to the other system. Therefore, the service providing system 10 can process the information that cannot conventionally be obtained and provide the obtained information to a client.

The information manager 50 comprises the presence manager 56, signaling manager 58, user manager 60 and role manager 62 that manage the presence information, signaling information, user information and role information, respectively. Similarly, the information manager 72 comprises the presence manager 76, signaling manager 78, user manager 80 and role manager 82. This configuration ensures reliable management in the respective systems.

More specifically, the information manager 50 comprises the presence manager 56 that comprises the information registration functional section 84, information change functional section 86, information search functional section 88, and information update notification access functional section 90 for processing presence information; the signaling manager 58 that comprises the 3PCC management functional section 92, B2BUA management functional section 94, 3PCC completion notification access functional section 96, and account information management access functional section 98; the user manager 60 that comprises the information registration functional section 100, information deletion functional section 102, information search functional section 104, information editing functional section 106, password authentication functional section 108, password change functional section 110, and location search functional section 112; and the role manager 62 that comprises the information registration functional section 114, information deletion functional section 116, information search functional section 118, and information editing functional section 120. The information manager 50 uses those functional sections to manage information processed in the SIP system 12 and accesses the web system 14 to obtain information not obtainable in the SIP system 12, thus allowing the clients to work together to process information in real time.

The information manager 72 comprises the components associated with those of the information manager 50. Specifically, it comprises the presence manager 76 that comprises the information registration access functional section 130, information change access functional section 132, information search access functional section 134, and information update notification functional section 136 for processing presence information; the signaling manager 78 that comprises the 3PCC management access functional section 138, B2BUA management access functional section 140, 3PCC completion notification functional section 142, and account information management functional section 144; the user manager 80 that comprises the information registration access functional section 146, information deletion access functional section 148, information search access functional section 150, information editing access functional section 152, password authentication access functional section 154, password change access functional section 156, and location search access functional section 158; and the role manager 82 that comprises the information registration access functional section 160, information deletion access functional section 162, information search access functional section 164, and information editing access functional section 166. The information manager 72 uses those functional sections to manage the information processed by the web system 14 and accesses the SIP system 12 to obtain information not obtainable only by the web system 14, thus allowing the clients to work together.

In this embodiment, the web system 14 has the web application 40 that generates an application. For example, the web application 40, which includes the role search application 70, generates the role search application 70 in response to a role search request from the web client 44, starts the cooperation manager 64 to work with the SIP system 12 that has information requested by the request, and obtains role information from the SIP system 12, with which the web system 14 is unified, in real time.

The web application 40 uses the role search application 70 that generates a search request for a database described based on role information that includes at least one of the division, the type of job, the business in charge, and the job title of an intended person. Therefore, the user is required only to update the base information, but is not required to change the application screen, even when the information is changed.

In the service providing system 10, the SIP system 12 and the web system 14 include processing systems, or computers. The cooperation manager 52 and the information manager 50 of the SIP system and the cooperation manager 64, the information manager 72, and the role search application 70 of the web system 14 are programs that cause the computers to run. This simplifies the system configuration.

The method providing a service is implemented in the following sequence. In response to the information 180 requested by the client 44 connected to the web system 14, the role search application 70 corresponding to the request information is generated, the start signal 186 including the request information from the application 70 is sent, this start signal 186 is supplied to the SIP system 12 with the protocol changed from the HTTP protocol to one of two communication protocols, that is, SOAP or CORBA, the selected communication protocol is changed to the SIP protocol in the SIP system 12, processing is performed in the SIP system 12 according to the management based on the supplied request information, and the obtained processing result is supplied to the web system 14 via the selected communication protocol. In this way, the information not obtainable in the web system 14 can be obtained from the SIP system 12 as the processing result and can be provided to the web client 44 via the application.

The application includes the function that generates a search request for a database described based on role information that includes at least one of the division, the type of job, the business in charge, and the job title of an intended person. Therefore, even when the information is changed, the change processing can be completed simply by updating the base information without changing the application screen and without changing the procedure. This makes the change operation easy.

The entire disclosure of Japanese patent application No. 2003-350594 filed on Oct. 9, 2003, including the specification, claims, accompanying drawings and abstract of the disclosure is incorporated herein by reference in its entirety.

While the present invention has been described with reference to the particular illustrative embodiment, it is not to be restricted by the embodiment. It is to be appreciated that those skilled in the art can change or modify the embodiment without departing from the scope and spirit of the present invention.

1. A service system for transferring information with clients connected to systems built in different communication protocol environments to provide the information as a service, comprising:
a first system operating based on a first communication protocol; and
a second system operating based on a second communication protocol,
said first system comprising:
a first cooperation management section for converting first information to be sent out to said second system into second information processable by a third communication protocol processing the second information so that the second information is processable both by the first communication protocol and the second communication protocol and for converting third information supplied from said second system and processed by the third communication protocol into fourth information processable by the first communication protocol; and
a first information management section including at least one of a management of information based on a function of an application operating in said first system and a management of accessing a corresponding application in said second system to start the application and obtaining information processed by the application and
said second system comprising:
a second cooperation management section for converting fifth information to be sent out to said first system into the third information processable by the third communication protocol and for converting the second information supplied from said first system and processed by the third communication protocol into sixth information processable by the second communication protocol; and
a second information management section including at least one of a management of information based on a function of an application operating in said second system and a management of accessing a corresponding application in said first system to start the application and obtaining information processed by the application.

2. The service system in accordance with claim 1, wherein said first information management section comprises subsections for managing presence information, signaling information, user information, and role information,
said second information management section comprising subsections for managing the presence information, the signaling information, the user information, and the role information corresponding to said first information management section.

3. The service system in accordance with claim 1, wherein said first information management section comprises:
a first subsection for managing presence information, said first subsection comprising a registration function block for the presence information; a change function block for the information; a search function block for the information; and a first function block for accessing a section for managing the presence information in said second information management section to notify an update of the information;
a second subsection for managing signaling information, said second section comprising a second function block for providing a communication between two clients via a server in said first system; a third function block for treating the two clients as separate sessions; a fourth function block for notifying a completion of the communication between the two clients to a subsection for managing the signaling information in said second information management section; and a fifth function block for accessing a subsection for managing the presence information in said second information management section performing account processing for a service upon completion of the communication;
a third subsection for managing user information, said third subsection comprising a registration function block for user information; a deletion function block for the information; a search function block for the information; an editing function block for the information; a sixth function block for authenticating a password of the user; a seventh function block for changing the password; and an eighth function block for searching for a location of the user; and
a fourth subsection for managing role information, said fourth subsection comprising a registration function block for the role information; a deletion function block for the information; a search function block for the information; and an editing function block for the information.

4. The service system in accordance with claim 2, wherein said first information management section comprises:
a first subsection for managing presence information, said first subsection comprising a registration function block for the presence information; a change function block for the information; a search function block for the information; and a first function block for accessing a section for managing the presence information in said second information management section to notify an update of the information;
a second subsection for managing signaling information, said second section comprising a second function block for providing a communication between two clients via a server in said first system; a third function block for treating the two clients as separate sessions; a fourth function block for notifying a completion of the communication between the two clients to a subsection for managing the signaling information in said second information management section; and a fifth function block for accessing a subsection for managing the presence information in said second information management section performing account processing for a service upon completion of the communication;
a third subsection for managing user information, said third subsection comprising a registration function block for user information; a deletion function block for the information; a search function block for the information; an editing function block for the information; a sixth function block for authenticating a password of the user; a seventh function block for changing the password; and an eighth function block for searching for a location of the user; and
a fourth subsection for managing role information, said fourth subsection comprising a registration function block for the role information; a deletion function block for the information; a search function block for the information; and an editing function block for the information.

5. The service system in accordance with claim 1, wherein said second information management section comprises:
a fifth subsection for managing presence information, said fifth section comprising access function blocks for accessing a registration function block for the present information, a change function block for the information, and a search function block for the information in said first information management section; and a ninth function block that is started when accessed by an information update notification supplied from a first function block;
a sixth subsection for managing signaling information, said sixth subsection comprising access function blocks for accessing second and third function blocks; a tenth function block for recognizing a completion upon receiving a notification from a fourth function block; and an eleventh function block for performing account processing in response to a notification from a fifth function block;
a seventh subsection for managing user information, said seventh subsection comprising access function blocks for accessing a registration function block for the user information, a deletion function block for the information, a search function block for the information, an editing function block for the information, and sixth to eighth function blocks in said first information management section; and
an eighth subsection for managing role information, said eighth subsection comprising access function blocks for accessing a registration function block for the roll information, a deletion function block for the information, a search function block for the information, and an editing function block for the information in said first information management section.

6. The service system in accordance with claim 2, wherein said second information management section comprises:
a fifth subsection for managing presence information, said fifth section comprising access function blocks for accessing a registration function block for the present information, a change function block for the information, and a search function block for the information in said first information management section; and a ninth function block that is started when accessed by an information update notification supplied from a first function block;
a sixth subsection for managing signaling information, said sixth subsection comprising access function blocks for accessing second and third function blocks; a tenth function block for recognizing a completion upon receiving a notification from a fourth function block; and an eleventh function block for performing account processing in response to a notification from a fifth function block;
a seventh subsection for managing user information, said seventh subsection comprising access function blocks for accessing a registration function block for the user information, a deletion function block for the information, a search function block for the information, an editing function block for the information, and sixth to eighth function blocks in said first information management section; and
an eighth subsection for managing role information, said eighth subsection comprising access function blocks for accessing a registration function block for the roll information, a deletion function block for the information, a search function block for the information, and an editing function block for the information in said first information management section.

7. The service system in accordance with claim 4, wherein said second information management section comprises:
a fifth subsection for managing presence information, said fifth section comprising access function blocks for accessing a registration function block for the present information, a change function block for the information, and a search function block for the information in said first information management section; and a ninth function block that is started when accessed by an information update notification supplied from a first function block;
a sixth subsection for managing signaling information, said sixth subsection comprising access function blocks for accessing second and third function blocks; a tenth function block for recognizing a completion upon receiving a notification from a fourth function block; and an eleventh function block for performing account processing in response to a notification from a fifth function block;
a seventh subsection for managing user information, said seventh subsection comprising access function blocks for accessing a registration function block for the user information, a deletion function block for the information, a search function block for the information, an editing function block for the information, and sixth to eighth function blocks in said first information management section; and
an eighth subsection for managing role information, said eighth subsection comprising access function blocks for accessing a registration function block for the roll information, a deletion function block for the information, a search function block for the information, and an editing function block for the information in said first information management section.

8. The service system in accordance with claim 1, wherein said second system further comprises an additional section for generating an application processing role information indicating a role of a target.

9. The service system in accordance with claim 2, wherein said second system further comprises an additional section for generating an application processing role information indicating a role of a target.

10. The service system in accordance with claim 4, wherein said second system further comprises an additional section for generating an application processing role information indicating a role of a target.

11. The service system in accordance with claim 7, wherein said second system further comprises an additional section for generating an application processing role information indicating a role of a target.

12. The service system in accordance with claim 11, wherein said additional section includes a function of generating a search request for a database described based on role information including at least one of a division, a type of job, a business in charge and a job title of the target.

13. A program for controlling a service system for transferring information with clients connected to systems built in different communication protocol environments to provide the information as a service, said service system comprising:
a first system operating based on a first communication protocol; and
a second system operating based on a second communication protocol,
said first system comprising:
a first cooperation management section for converting first information to be sent out to said second system into second information processable by a third communication protocol processing the second information so that the second information is processable both by the first communication protocol and the second communication protocol and for converting third information supplied from said second system and processed by the third communication protocol into fourth information processable by the first communication protocol; and
a first information management section including at least one of a management of information based on a function of an application operating in said first system and a management of accessing a corresponding application in said second system to start the application and obtaining information processed by the application and
said second system comprising:
a second cooperation management section for converting fifth information to be sent out to said first system into the third information processable by the third communication protocol and for converting the second information supplied from said first system and processed by the third communication protocol into sixth information processable by the second communication protocol; and
a second information management section including at least one of a management of information based on a function of an application operating in said second system and a management of accessing a corresponding application in said first system to start the application and obtaining information processed by the application,
wherein said first system and said second system comprise computers,
said program causing said first system to function as said first cooperation management section and said first information management section, and said second system to function as said second cooperation management section, said second information management section, and an additional section for generating an application processing role information.

14. The program in accordance with claim 13, wherein said first information management section comprises subsections for managing presence information, signaling information, user information, and role information,
said second information management section comprising subsections for managing the presence information, the signaling information, the user information, and the role information corresponding to said first information management section.

15. The program in accordance with claim 13, wherein said first information management section comprises:
a first subsection for managing presence information, said first subsection comprising a registration function block for the presence information; a change function block for the information; a search function block for the information; and a first function block for accessing a section for managing the presence information in said second information management section to notify an update of the information;
a second subsection for managing signaling information, said second section comprising a second function block for providing a communication between two clients via a server in said first system; a third function block for treating the two clients as separate sessions; a fourth function block for notifying a completion of the communication between the two clients to a subsection for managing the signaling information in said second information management section; and a fifth function block for accessing a subsection for managing the presence information in said second information management section performing account processing for a service upon completion of the communication;
a third subsection for managing user information, said third subsection comprising a registration function block for user information; a deletion function block for the information; a search function block for the information; an editing function block for the information; a sixth function block for authenticating a password of the user; a seventh function block for changing the password; and an eighth function block for searching for a location of the user; and
a fourth subsection for managing role information, said fourth subsection comprising a registration function block for the role information; a deletion function block for the information; a search function block for the information; and an editing function block for the information.

16. The program in accordance with claim 13, wherein said second information management section comprises:
a fifth subsection for managing presence information, said fifth section comprising access function blocks for accessing a registration function block for the present information, a change function block for the information, and a search function block for the information in said first information management section; and a ninth function block that is started when accessed by an information update notification supplied from a first function block;
a sixth subsection for managing signaling information, said sixth subsection comprising access function blocks for accessing second and third function blocks; a tenth function block for recognizing a completion upon receiving a notification from a fourth function block; and an eleventh function block for performing account processing in response to a notification from a fifth function block;
a seventh subsection for managing user information, said seventh subsection comprising access function blocks for accessing a registration function block for the user information, a deletion function block for the information, a search function block for the information, an editing function block for the information, and sixth to eighth function blocks in said first information management section; and
an eighth subsection for managing role information, said eighth subsection comprising access function blocks for accessing a registration function block for the roll information, a deletion function block for the information, a search function block for the information, and an editing function block for the information in said first information management section.

17. The program in accordance with claim 13, wherein said second system further comprises a further additional section for generating an application processing role information indicating a role of a target.

18. The program in accordance with claim 17, wherein said further additional section includes a function of generating a search request for a database described based on role information including at least one of a division, a type of job, a business in charge and a job title of the target.

19. A method of transferring information with clients connected to systems built in different communication protocol environments for providing the information as a service, comprising:
a first step of preparing a first system operating based on a first communication protocol, and a second system operating based on a second communication protocol, information being transferred between the first system and the second system;
a second step of converting first information to be sent out from the first system into second information processable by a third communication protocol, and sending out the second information, the third communication protocol processing the second information so that the second information is processable both by the first communication protocol and the second communication protocol;
a third step of converting the second information supplied to the second system into third information processable by the second communication protocol, and outputting the information;
a fourth step of converting fourth information to be sent out from the second system and processable by the second communication protocol into fifth information processable by the third communication protocol, and sending out the information;
a fifth step of converting the fifth information supplied to the first system into sixth information processable by the first communication protocol, and outputting the sixth information,
a sixth step of generating an application in the second system in response to seventh information requested by a client connected to the second system, and sending out a start signal including the seventh information; and
a seventh step of sequentially performing said fourth step and said fifth step via the start signal, performing processing under a management based on the supplied seventh information in said first system, supplying a result obtained from the processing to said second system via said second and third steps, and sending out the result via the application to the client connected to said second system.

20. The method in accordance with claim 19, wherein the application includes a function of generating a search request for a database described based on role information including at least one of a division, a type of job, a business in charge and a job title of a target.
